(19) United States
(12) Patent Application Publication
(10) Pub. No.: US 2025/0176772 A1
(43) Pub. Date: Jun. 5, 2025

(54) SUCTION AND BLOWING INTEGRATED CARE MACHINE

(71) Applicant: Guangdong Yinuo Pet Intelligent Technology Co., Ltd., Dongguan (CN)

(72) Inventors: Bo ZHU, Dongguan (CN); Song LI, Dongguan (CN)

(73) Assignee: Guangdong Yinuo Pet Intelligent Technology Co., Ltd., Dongguan (CN)

(21) Appl. No.: 18/533,480

(22) Filed: Dec. 8, 2023

(30) Foreign Application Priority Data
Dec. 1, 2023 (CN) 2023116369119

(51) Int. Cl. A47L 9/14; A01K 13/00; A47L 5/36; A47L 9/12; A47L 9/22; A47L 9/26; A47L 9/28; A47L 9/32

(52) U.S. Cl. CPC A47L 9/1427; A01K 13/001; A47L 5/362; A47L 9/122; A47L 9/1409; A47L 9/22; A47L 9/26; A47L 9/28; A47L 9/327

(57) ABSTRACT

The present invention discloses a suction and blowing integrated care machine and relates to the technical field of pet supplies. The suction and blowing integrated care machine comprises a base, an upper portion of the base is fixedly connected with a shell, the interior of the shell is hollow, and a fan is fixedly mounted therein, one end of the shell is connected with a dust collection box, the shell is in communication with the dust collection box, the other end of the shell is provided with a suction port and a blowing port respectively, a suction channel in communication with the dust collection box and the suction port is reserved at the bottom of the shell, a heating channel is further reserved in the shell, and the interior of the shell, the dust collection box and the blowing port are in communication with each other.

### CROSS-REFERENCE TO RELATED APPLICATIONS

The application claims priority to Chinese patent application No. 2023116369119, filed on Dec. 1, 2023, the entire contents of which are incorporated herein by reference.

### TECHNICAL FIELD

The present invention relates to the technical field of pet supplies, in particular to a suction and blowing integrated care machine.

### BACKGROUND

The care machine is one of the commonly used equipment for pets, the main function thereof is to suck shed hair from pets' body. Existing care machines usually only have a function of sucking hair. The wind energy generated by the kinetic energy of a fan is discharged from an air outlet of the care machine after assisting in sucking of hair, and the wind energy is not fully utilized, resulting in a waste of energy. Therefore, a person skilled in the art proposes a suction and blowing integrated care machine.

### SUMMARY

In view of the shortcomings of the prior art, the present invention provides a suction and blowing integrated care machine, which solves the problem raised in the background above.

In order to achieve the above object, the present invention is implemented through the following technical solution: a suction and blowing integrated care machine comprises a base, an upper portion of the base is fixedly connected with a shell, the interior of the shell is hollow, and a fan is fixedly mounted therein, one end of the shell is connected with a dust collection box, the shell is in communication with the dust collection box, the other end of the shell is provided with a suction port and a blowing port respectively, a suction channel in communication with the dust collection box and the suction port is reserved at the bottom of the shell, a heating channel is further reserved in the shell, and the interior of the shell, the dust collection box and the blowing port are in communication with each other and form a blowing channel together.

Further, the exterior of the shell is movably connected with a handle for improving portability.

Further, the interior of the base is fixedly connected with a winding frame for winding of a power cord.

Further, an inner bottom end of the dust collection box is connected with a dust guide sleeve, the height of the dust guide sleeve is at least one third of the inner height of the dust collection box, and the interior of the dust guide sleeve is in communication with the suction channel and the dust collection box respectively.

Further, a first filter element and a protective net are fixedly disposed respectively at a part where the shell and the dust collection box are in communication with each other, and the protective net is located in front of the first filter element in a flow direction of an airflow.

Further, a second filter element is fixedly disposed at a position where the shell is in communication with the heating channel.

Further, the interior of the heating channel is fixedly provided with a heating wire used for heating the airflow.

Further, the shell is connected with a top portion and a bottom portion of the dust collection box jointly by means of a first snap-fit structure and a second snap-fit structure respectively.

Further, the first snap-fit structure comprises a rotary buckle rotationally connected to a top portion of the dust collection box and a buckle protrusion fixedly connected to a top portion of the shell, wherein the rotary buckle is able to be fixed to the buckle protrusion in a snap-fit manner after rotating clockwise by 180°.

Further, the second snap-fit structure comprises a plurality of slots formed at a bottom end of the dust collection box and a plurality of tab protrusions fixedly connected to an inner bottom end of the shell, and the slots are fixed to the tab protrusions in a snap-fit manner when the dust collection box is horizontally pushed into the shell.

The present invention provides a suction and blowing integrated care machine. Compared with the prior art, it has the following beneficial effects:

In addition to a channel for sucking of the airflow, the suction and blowing integrated care machine is also provided with a channel for blowing of the airflow simultaneously in the internal structure, therefore, it can be applied to different scenarios, the waste of existing energy is avoided, the airflow blowing out can be used for drying the hair of pets, etc., and the practicality of existing care machines can be greatly improved.

### BRIEF DESCRIPTION OF DRAWINGS

FIG. 1 is a structural schematic diagram from a first view according to the present invention;

FIG. 2 is a structural schematic diagram from a second view according to the present invention;

FIG. 3 is a side view of the present invention;

FIG. 4 is a stereo sectional view of A-A in FIG. 3 of the present invention;

FIG. 5 is a stereo sectional view of B-B in FIG. 3 of the present invention;

FIG. 6 is a schematic diagram of the snap-fit structures of the present invention;

FIG. 7 is a schematic diagram showing snap-fit engagement between the slots and the tab protrusions of the present invention; and

FIG. 8 is a structural schematic diagram of the bottom of the dust collection box of the present invention.

Reference numerals: 1. base; 2. shell; 3. dust collection box; 31. rotary buckle; 32. buckle protrusion; 33. slot; 34. tab protrusion; 4. handle; 5. suction port; 6. blowing port; 7. winding frame; 8. suction channel; 9. dust guide sleeve; 10. first filter element; 11. protective net; 12. fan; 13. heating channel; 14. heating wire; 15. second filter element.

### DETAILED DESCRIPTION OF THE EMBODIMENTS

The technical solutions in embodiments of the present invention are described clearly and completely below with reference to the accompanying drawings of the embodiments of the present invention. Obviously, the described embodiments are only part of the embodiments according to the present invention, rather than all of the embodiments. Based on the embodiments in the present invention, all other embodiments obtained by those of ordinary skill in the art without making creative efforts fall within the scope of protection of the present invention.

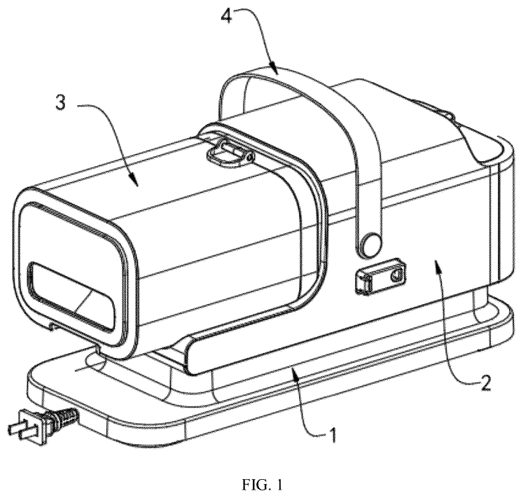

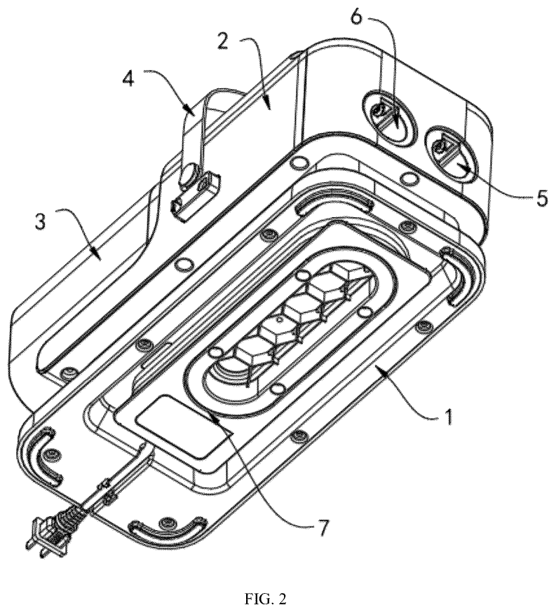

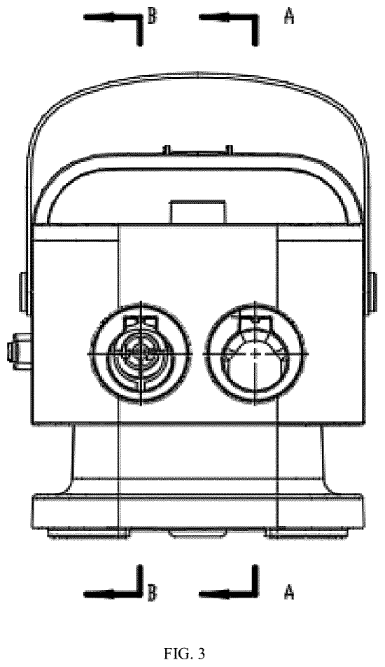

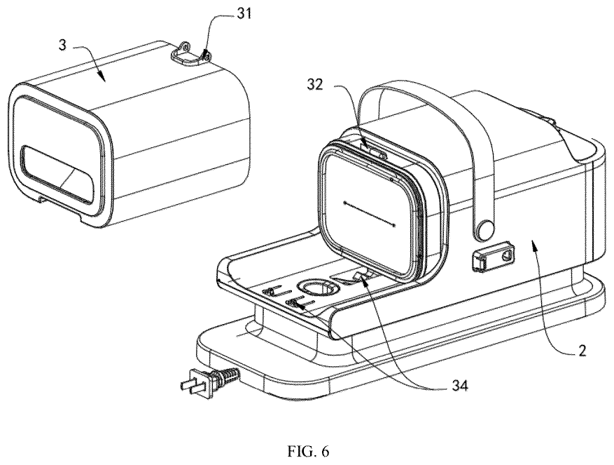

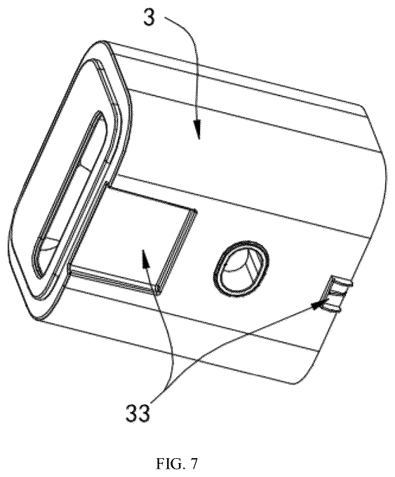

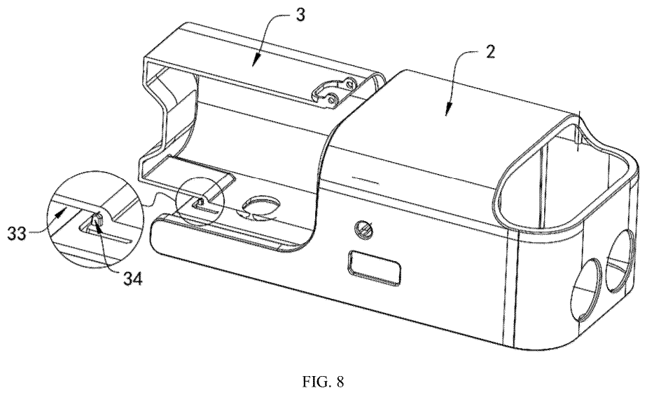

Referring to FIGS. 1-8, the present invention provides the following technical solution: a suction and blowing integrated care machine comprises a base 1, the interior of the base 1 is fixedly connected with a winding frame 7 for winding of a power cord, an upper portion of the base 1 is fixedly connected with a shell 2, the exterior of the shell 2 is movably connected with a handle 4 for improving portability, the interior of the shell 2 is hollow, and a fan 12 is fixedly mounted therein, one end of the shell 2 is connected with a dust collection box 3 (the dust collection box 3 can be removed from the shell 2, as shown in FIG. 6 and FIG. 7, the shell 2 is connected with a top portion and a bottom portion of the dust collection box 3 jointly by means of a first snap-fit structure and a second snap-fit structure respectively, the first snap-fit structure comprises a rotary buckle 31 rotationally connected to a top portion of the dust collection box 3 and a buckle protrusion 32 fixedly connected to a top portion of the shell 2, wherein the rotary buckle 31 is able to be fixed to the buckle protrusion 32 in a snap-fit manner after rotating clockwise by 180°, the second snap-fit structure comprises a plurality of slots 33 formed at a bottom end of the dust collection box 3 and a plurality of tab protrusions 34 fixedly connected to an inner bottom end of the shell 2, and the slots 33 are fixed to the tab protrusions 34 in a snap-fit manner when the dust collection box 3 is horizontally pushed into the shell 2), the shell 2 is in communication with the dust collection box 3, and the other end of the shell 2 is provided with a suction port 5 and a blowing port 6 respectively. A suction channel 8 in communication with the dust collection box 3 and the suction port 5 is reserved at the bottom of the shell 2. An inner bottom end of the dust collection box 3 is connected with a dust guide sleeve 9, the height of the dust guide sleeve 9 is at least one third of the inner height of the dust collection box 3, and the interior of the dust guide sleeve 9 is in communication with the suction channel 8 and the dust collection box 3 respectively. The protruding dust guide sleeve 9 ensures that after dust accumulates inside the dust collection box 3, the dust at the bottom is not easily stirred up by airflow. A heating channel 13 is further reserved in the shell 2, the interior of the heating channel 13 is fixedly provided with a heating wire 14 for heating the airflow, so that a hot airflow can be blown out by the fan 12. The interior of the shell 2, the dust collection box 3 and the blowing port 6 are in communication with each other and form a blowing channel together, A first filter element 10 and a protective net 11 are fixedly disposed respectively at a part where the shell 2 and the dust collection box 3 are in communication with each other. The protective net 11 is of a stainless steel mesh structure, which can provide protection for the filter elements and the fan 12 therebehind. The protective net 11 is located in front of the first filter element 10 in the flow direction of airflow. A second filter element 15 is fixedly disposed at a position where the shell 2 is in communication with the heating channel 13. Both of the first filter element 10 and the second filter element 15 are used for filtering the airflow. Additionally, it should be noted that the suction port of the fan 12 faces the dust collection box 3, while the blowing port faces the heating channel 13.

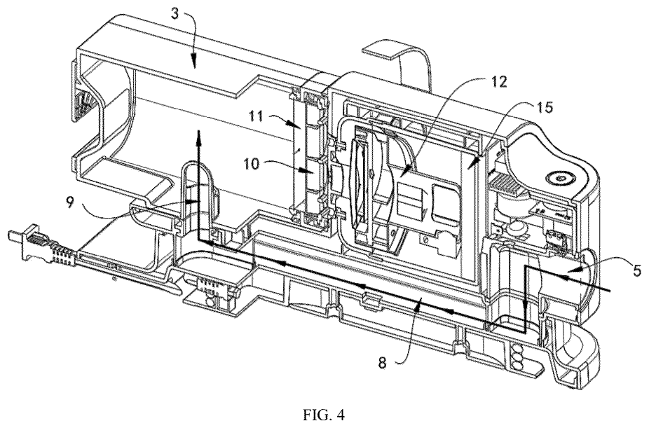

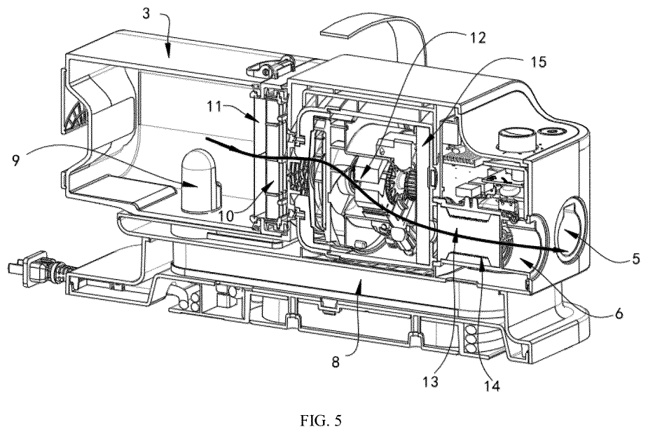

In use, the fan 12 operates, external air is drawn in through the suction port 5 and sequentially passes through the suction channel 8 and the dust guide sleeve 9, and finally enters the interior of the dust collection box 3 (the suction path is shown by the black line in FIG. 4), so as to achieve a suction function. Meanwhile, the airflow entering the dust collection box 3 sequentially passes through the first filter element 10 and the protective net 11 and then reaches a chamber where the fan 12 is located. At that time, the temperature of the airflow is still at ambient temperature, which can absorb the heat generated by the operation of the fan 12, in this way, the temperature of the airflow increases slightly. Subsequently, the airflow enters the heating channel 13, where the heating wire 14 heats the airflow, and finally, hot air is blown out from the blowing port 6 (the blowing path is shown by the black line in FIG. 5). In this way, the entire care machine has an integrated suction and blowing function during operation. Users can connect equipments to the suction port 5 and the blowing port 6 according to their needs and use them either selectively or simultaneously. For example, in the scenario of a pet shop, the suction port 5 can be connected with a pipe to suck hair for one pet, while the blowing port 6 can be connected with a pipe to dry the hair of another pet, the care machine can be used in similar scenarios as well.

What is claimed is:

1. A suction and blowing integrated care machine, comprising a base (1), wherein an upper portion of the base (1) is fixedly connected with a shell (2), the interior of the shell (2) is hollow, and a fan (12) is fixedly mounted therein, one end of the shell (2) is connected with a dust collection box (3), the shell (2) is in communication with the dust collection box (3), and the other end of the shell (2) is provided with a suction port (5) and a blowing port (6) respectively, a suction channel (8) in communication with the dust collection box (3) and the suction port (5) is reserved at the bottom of the shell (2), and a heating channel (13) is further reserved in the shell (2), the interior of the shell (2), the dust collection box (3) and the blowing port (6) are in communication with each other and form a blowing channel together.

2. The suction and blowing integrated care machine according to claim 1, wherein the exterior of the shell (2) is movably connected with a handle (4) for improving portability.

3. The suction and blowing integrated care machine according to claim 1, wherein the interior of the base (1) is fixedly connected with a winding frame (7) for winding of a power cord.

4. The suction and blowing integrated care machine according to claim 1, wherein an inner bottom end of the dust collection box (3) is connected with a dust guide sleeve (9), the height of the dust guide sleeve (9) is at least one third of the inner height of the dust collection box (3), and the interior of the dust guide sleeve (9) is in communication with the suction channel (8) and the dust collection box (3) respectively.

5. The suction and blowing integrated care machine according to claim 1, wherein a first filter element (10) and a protective net (11) are fixedly disposed respectively at a part where the shell (2) and the dust collection box (3) are in communication with each other, and the protective net (11) is located in front of the first filter element (10) in a flow direction of an airflow.

6. The suction and blowing integrated care machine according to claim 5, wherein a second filter element (15) is fixedly disposed at a position where the shell (2) is in communication with the heating channel (13).

7. The suction and blowing integrated care machine according to claim 1, wherein the interior of the heating channel (13) is fixedly provided with a heating wire (14) for heating the airflow.

8. The suction and blowing integrated care machine according to claim 1, wherein the shell (2) is connected with a top portion and a bottom portion of the dust collection box (3) jointly by means of a first snap-fit structure and a second snap-fit structure respectively.

9. The suction and blowing integrated care machine according to claim 8, wherein the first snap-fit structure comprises a rotary buckle (31) rotationally connected to a top portion of the dust collection box (3) and a buckle protrusion (32) fixedly connected to a top portion of the shell (2), wherein the rotary buckle (31) is able to be fixed to the buckle protrusion (32) in a snap-fit manner after rotating clockwise by 180°.

10. The suction and blowing integrated care machine according to claim 8, wherein the second snap-fit structure comprises a plurality of slots (33) formed at a bottom end of the dust collection box (3) and a plurality of tab protrusions (34) fixedly connected to an inner bottom end of the shell (2), and the slots (33) are fixed to the tab protrusions (34) in a snap-fit manner when the dust collection box (3) is horizontally pushed into the shell (2).
